(19) United States
(12) Patent Application Publication
(10) Pub. No.: US 2012/0330512 A1
(43) Pub. Date: Dec. 27, 2012

(54) METHOD FOR TRIGGERING AT LEAST ONE IRREVERSIBLE RETAINING DEVICE OF A MOTOR VEHICLE

(75) Inventor: Mirko Mählisch, Gaimersheim (DE)

(73) Assignee: Audi AG, Ingolstadt (DE)

(21) Appl. No.: 13/528,263

(22) Filed: Jun. 20, 2012

(30) Foreign Application Priority Data
Jun. 22, 2011 (DE) 10 2011 105 356.9

(51) Int. Cl. B60R 21/0134

(52) U.S. Cl. 701/45

(57) ABSTRACT

A method for triggering at least one irreversible retaining device of a motor vehicle before the beginning of an actual collision includes acquiring items of information regarding an object which is present in the vicinity of the motor vehicle by means of at least two acquisition devices of a motor vehicle which operate independent of one another and which continuously measure the vicinity of the vehicle, and separately analyzing the items of information with regard to whether triggering conditions for triggering the at least one irreversible retaining device are established, wherein the triggering only occurs when both analysis results indicate that the triggering conditions are established.

### CROSS-REFERENCES TO RELATED APPLICATIONS

This application claims the priority of German Patent Application, Serial No. 10 2011 105 356.9, filed Jul. 6, 2011, pursuant to 35 U.S.C. 119(a)-(d), the disclosure of which is incorporated herein by reference.

### BACKGROUND OF THE INVENTION

The present invention relates to a method for triggering at least one irreversible retaining device of a motor vehicle before an actual collision.

The following discussion of related art is provided to assist the reader in understanding the advantages of the invention, and is not to be construed as an admission that this related art is prior art to this invention.

Irreversible retaining devices, which are installed in motor vehicles are usually of the type which are activated pyrotechnically. Examples therefore are airbags, which are inflated by pyrotechnical activation, or pyrotechnic belt tensioner, which tension the belt via pyrotechnic activation and in this way position the driver correspondingly. With regard to the activation, two principally different approaches are known. On one hand, the activation can only occur when the vehicles actually contact one another, i.e. the collision occurs and is detected by sensors. However, it is also known to trigger an irreversible retaining device shortly before the actual time point of collision, which is usually referred to as to time point. This early triggering has the advantage, for example in the case of an airbag, that a slightly longer period of time is available for inflating the airbag or respectively, that the airbag at the time point at which the person impacts the airbag can be inflated to a larger volume, which increases the protection of the occupants. On the other hand, the inflation process can be configured to be less aggressive due to the available longer inflation time, which decreases the risk of injury in so called “out-of-position” cases, in which the person is seated in a disadvantageous position relative to the inflating airbag. Also, the temporal pre-triggering of pyrotechnic belt tensioners is advantageous because also in this case the tensioning process can be configured to be less aggressive, because a longer period of time for optimally positioning the occupants or respectively, for building up a counter acceleration is available.

A prerequisite for the temporal pre-triggering is that predefined triggering conditions are satisfied which indicate that a triggering situation is actually given in which a collision is immediately impending. These triggering conditions are stored in a suitable control device for the retaining system, of which the retaining device is a part. In order to be able to check whether the triggering conditions are satisfied, i.e. a triggering of the irreversible retaining device at a defined time point is to occur, items of information are acquired from the vicinity of the motor vehicle by means of suited acquisition devices such as cameras, radar sensors and the like and for example analyzed by the control device of the retaining system. Such a system is for example known from DE 10 2008 059 240 A1. A first acquisition device is a spectroscopic camera, a second acquisition device is provided in the form of one or multiple radar sensors. With the camera, optical images of the area in front of the vehicle are recorded and analyzed with regard to objects in this area. The radar system has also a relatively great acquisition range in the area in front of the vehicle, so that information regarding an object which is present in the area in front of the vehicle can also be derived from the radar system, wherein the radar system has a greater, farther extending acquisition range than the camera system. All items of information recorded by both acquisition devices are fed to the control device, where they are quasi fused, i.e. cumulatively analyzed. Based on all cumulatively considered items of information i.e. that they are derived immediately from the acquired data, or are determined by analyzing these data, the control device now determines whether all triggering conditions which are defined by the system are satisfied. In this case it is not differentiated from which acquisition system the information with regard to a defined triggering condition originates, it is only required that overall all triggering conditions are satisfied by the cumulatively present items of information of the acquisition device. Parallel to this, the triggering parameters for example the triggering time point or a defined triggering characteristic are calculated, based on which the triggering device is controlled when the latter is actually to be triggered. The triggering occurs when on one hand the cumulative information processing results in all triggering conditions being satisfied, on the other hand, when the triggering time point is given.

The safety level of this triggering process is not very high, because the data are processed cumulatively. Simple errors within the data acquisition can lead to erroneous triggering.

It would therefore be desirable and advantageous to provide a system which enables to determine the presence of the triggering condition on a safe basis, or respectively to only release the triggering when it is ensured that a corresponding situation is also given.

### SUMMARY OF THE INVENTION

The method according to the invention includes analyzing, whether or not the items of information of each individual acquisition system when considered in isolation, or respectively items of information derived from these items of information satisfy the triggering conditions. Each information data set is thus analyzed and verified separately with regard to whether a situation is given or respectively is described, which is suited to pre-trigger the irreversible retaining device. The two separate results of the analyses are then quasi “and” linked, i.e. ultimately compared, to determine whether both results of the analyses correspond insofar that the respective triggering conditions were determined to be satisfied. Only when this comparison indicates that the presence of the triggering conditions was established twice independently, the triggering is released in general and the triggering carried out at the given time point based on the determined triggering parameters.

For triggering before the impact, the triggering conditions thus have to be verified by two independent forward looking acquisition systems or respectively, the items of information provided by the forward looking acquisition systems checked with regard to whether these items of information are suited to describe a situation which satisfies the triggering conditions. Each acquisition system thus has to be capable to determine all parameters which are necessary for verifying these conditions by itself or respectively provide data which can be analyzed in this regard. Because the data analysis is preferably carried out in the control device of the retaining system, the control device thus has to be capable to perform a processing or respectively analysis based on the system-specific data via a suitable processing or analysis device. This analysis has to be capable for example to determine data such as the so called TTC value (TTC=time to collision), the object mass classes, the object width, the site of impact, the time point of impact, the angle of impact etc. which can be generally regarded as triggering conditions. These items of information or respectively parameters have to be determined separately for the information data sets of both acquisition systems so that the triggering conditions are present completely redundantly.

This achieves a maximal level safety, because verification that a situation is given which satisfies the triggering conditions occurred via at least two independent systems, and as a result an early triggering of the irreversible retaining system is justified.

In a refinement of the invention, at least one further acquisition device can be used which also provides object related items of information, which are also analyzed with regard to the presence of the triggering conditions, wherein the triggering only occurs when the third analysis result also indicates the presence of the triggering conditions. The inclusion of a third acquisition device and separate verification of the information provided by the latter leads to an over-redundant configuration of the system whereby the safety standard is further improved, because the triggering only occurs when three separately confirmed triggering conditions are present. It is also conceivable of course to also include multiple further acquisition devices, if such further acquisition devices are installed. Each included acquisition device provides corresponding items of information, which are respectively analyzed separately and contribute separate analysis results, wherein the triggering occurs when all analysis results are positive.

As described, it is also necessary, parallel to the checking of the triggering conditions, to determine corresponding trigger parameters such as for example the time point of the triggering or the triggering characteristic, when for example the pyrotechnic ignition characteristic is variable. Expediently, the items of information of all acquisition systems are used for this, which means that the calculation of the trigger parameters occurs not only based on the items of information of one acquisition system, but both or all three included acquisition systems. This also increases the accuracy of the parameter determination.

Preferably, different types of acquisition devices are used for the acquisition of the items of information. Here, a mono camera, a PMD-sensor, a stereo camera or radar sensors can be used as acquisition device, wherein any desired combinations are possible. For example, a mono camera and a PMD-sensor can be used. As an alternative, a stereo camera and a PMD-sensor can be used. A further possible combination is the use of a stereo camera and one or multiple high resolution object classifying radar sensors. Finally, a PMD sensor and one or multiple high resolution object classifying radar sensors can also be used. When three acquisition devices are used, the corresponding exemplary named combinations can include a further of the named devices.

In a refinement of the invention, it is possible to acquire items of information relating to the object in addition to the two or the three acquisition devices, which items of information are considered during the analysis of the triggering conditions and/or the determination of the triggering parameter. Modern motor vehicles are increasingly equipped with so called car-to-car-communication, which allow wirelessly querying corresponding data and information from an oncoming vehicle or a vehicle driving in front which has a corresponding communication device. If the own vehicle is provided with such a device, and the possibly colliding vehicle also has such a device, a corresponding data exchange can occur, wherein these data or respectively, these items of information are taken correspondingly into account when determining the presence of the triggering conditions or the triggering parameters.

Beside the method, the invention also relates to a motor vehicle which includes at least one irreversible retaining system with a retaining device which can be triggered before occurrence of the actual collision, as well as at least two acquisition devices which operate independent of each other and which continuously measure the vicinity other the vehicle, by means of which items of information relating to an object which is present in the vicinity are detected which items of information are analyzed by the control device with regard to whether triggering conditions which have to be satisfied for triggering the retaining device are established. This motor vehicle is characterized according to the invention in that the control device is configured for separately analyzing the items of information of each acquisition device with regard to whether the triggering conditions are established, as wells as for triggering the retaining device only when both analysis results indicate the presence of the triggering conditions.

Thus, the control device performs a redundant analysis whether a collision is likely and the triggering conditions are satisfied and compares the analyses, wherein the triggering actually only takes place when both analyses have the same result.

Expediently, the motor vehicle according to the invention can include a further acquisition device, which also provides object related items of information, wherein the control device is also configured for separately analyzing these items of information with regard to the presence of the triggering conditions and for triggering only when the third analysis result also indicates the presence of the triggering conditions.

The determination of the triggering parameters, which are required or respectively, have to be processed for the triggering of the pyrotechnic retaining device occurs expediently by the control device based on the items of information of all acquisition devices, wherein the acquisition devices are preferably of different types. A mono camera, a stereo camera, a PMD-sensor or radar sensor can be used as acquisition.

Finally, items of information can also be acquired via a vehicle-to-vehicle-communication device for determining object related items of information and be acquired during the analysis of the triggering conditions and/or the triggering parameters.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic representation of a motor vehicle according to the invention, and

FIG. 2 is a diagram for illustrating the sequence of the method according to the invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

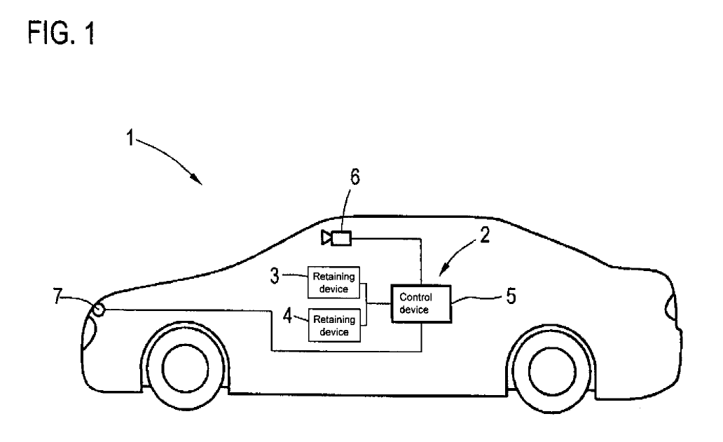

Turning now to the drawing, and in particular to FIG. 1, there is shown a schematic representation of a motor vehicle 1 according to the invention, including an irreversible retaining system 2, which includes two separate retaining devices 3, 4. The retaining device 3 can be for example an airbag, the retaining device 4 can be a belt tensioner. Both retaining devices are pyrotechnical in nature, i.e. they are operated via a pyrotechnic charge which is to be ignited when needed.

In the shown example, both irreversible retaining devices are assigned a common control device 5, wherein however, as an alternative to the here shown exemplary embodiment, each retaining device 3, 4 can be assigned an own control device, so that each pair of retaining device and control device forms a separate retaining system. The control device 5 processes the data provided to it to determine whether a collision is immediately impending, i.e. whether triggering conditions are satisfied so that an actuation of the retaining devices 3 and/or 4 is required, and also determines the triggering parameters in particular the triggering time point based on the items of information or respectively, data provided to it or, based on data which have been determined based on these items of information or respectively, data.

For this, the motor vehicle according to the invention shown in the exemplary embodiment has two separate acquisition devices 6, 7 of different types. The acquisition device 6 is for example a mono camera or a stereo camera or a PMD sensor, while the acquisition device 7 is for example one or multiple radar sensors which are installed front side. Both acquisition devices 6, 7 respectively, record the area in front of the vehicle, the acquisition device 6 for example, in the form of a camera, in form of images, the radar sensor in form of corresponding position resolved scanning signals. The items of information relating to the area in front of the vehicle acquired via the acquisition devices are respectively provided to the control device 5 in the shown exemplary embodiment, the latter thus receives the information relating to the area in front of the vehicle of the acquisition device 6 as well as the acquisition device 7. The individual items of information are processed by the control device, namely in such a way that the respective items of information are processed separate from one another. The control device 5 thus separately analyzes on one hand the image data provided by the first acquisition device i.e. the camera, on the other hand separately the scanning data provided by the radar sensor or radar sensors i.e. the second acquisition device 7. The separate analysis of the respective items of information or respectively, data has the purpose to determine whether the items of information describe the presence of predefined triggering conditions, or respectively, whether based on these items of information respective data can be determined which satisfy the triggering conditions. The acquisition devices 6, 7 are thus in general terms sensors which provide items of information which are analyzed with regard to relevant parameters which define the triggering conditions. Such parameters or respectively, triggering conditions can for example be the TTC value (TTC=time-to-collision), the object mass class, the width of the object or the height of the object, the site of impact, the time point of the impact or the angle of impact. All of these are thus data which provide items of information relating to a possible impending collision of the own motor vehicle with an object, which can be detected within the items of information which are provided by each of the acquisition devices 6, 7 via the control device 5 by suitable processing algorithms.

Based on the information data set of the first and the second acquisition devices 6, 7, the control device 5 now checks whether the separate information set satisfies or respectively, describes the predefined triggering conditions. If this is the case, a collision is likely and action is required. The control device 5 now compares the respective device-specific analysis results and controls one or both retaining devices 3, 4 only when both analysis results are the same, i.e. the result of both analyzes is that the triggering conditions are described as established by the first acquisition device as well as the second acquisition device 7.

Parallel to the analysis with regard to the presence of the triggering conditions by the control device 5 based on the items of information of both acquisition devices 6, 7 i.e., based on the cumulatively processed items of information, the triggering parameters are determined, in particular the time point of the triggering which may have to be carried out, so that the parameters are present at the same time as the analysis result with regard to the triggering conditions. Beside the triggering time point, a defined triggering characteristic which forms the basis of the triggering can also be determined via the cumulatively processed items of information. For example, the retaining device can be an airbag with a two-stage gas generator. A first slow stage in which a small amount of gas is delivered, is for example triggered first when the result of the analyses is that the triggering conditions have been met. This means that a pre-triggering before the actual impact is thereby initiated in which a smaller amount of gas is delivered. A second fast ignition stage in which an increased amount of gas is delivered together with the slow ignition stage is then controlled by a vehicle internal delay sensor system in the case of the conventional triggering, for example when this vehicle sensor system has sensed the actual collision. The second ignition stage can also be switched on when the time point of the impact was determined too late by the environmental sensor system, i.e. the devices 6, 7 and the vehicle internal delay sensor system, for example suitable acceleration sensors already sense an impact which justifies triggering already before the time point of the impact determined by the acquisition devices 6, 7 or respectively, the control device 5.

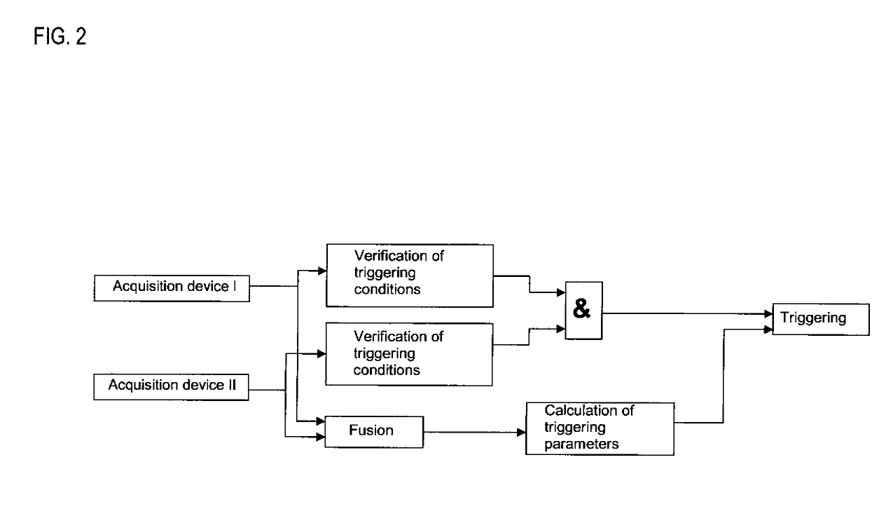

FIG. 2 shows a schematic diagram which describes the method according to the invention in more detail. Shown are the first and the second acquisition devices, which continuously provide items of acquisition information. As shown by the diagram, the items of information of the acquisition device I are separately checked with regard to the presence of the triggering conditions. The same applies to the items of information of the acquisition device II. The checking and analysis results are subsequently compare with one another, as represented by the “&”.

Parallel to this, the items of information of the first and the second acquisition devices are fused as shown. This fusion of data or items of information forms the basis of the triggering parameters, i.e. as described, in particular the triggering time point. In the next step, when the comparison of the analyses results has shown that both information data sets describe the presence of the triggering conditions, the triggering is carried out in accordance with the calculated triggering parameters.

Finally, it is noted that instead of using two separate acquisition devices of different types one or multiple acquisition devices which are preferably also of different types, can be integrated into the system. The items of information of these further acquisition devices are also separately analyzed by the control device with regard to the triggering conditions, a release of the triggering would then only be possible when this third or respectively each further analysis result matches the other two. The items of information would further also be processed cumulatively during the data fusion for calculating the triggering parameters. Items of information of a not shown car-to-car-communication device can also be processed during the verification with regard to the triggering conditions or respectively, during the determination of the triggering parameters.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for triggering at least one irreversible retaining device of a motor vehicle before an actual collision of the motor vehicle, comprising:
acquiring a first item of information relating to an object present in a vicinity of the motor vehicle with one of at least two acquisition devices of the motor vehicle and, independent of the one of the at least two acquisition devices, acquiring a second item of information relating to the object with another one of the at least two acquisition devices, said at least two acquisition devices continuously measuring a vicinity of the motor vehicle;
analyzing the first and second items of information independent of one another with regard to whether triggering conditions for triggering of the at least one irreversible retaining device are established; and
triggering the irreversible retaining device only when results of the analyses of the first and second items of information indicate that the triggering conditions are established.

2. The method of claim 1, wherein the acquiring step further includes acquiring a third item of information relating to the object with at least one further acquisition device of the motor vehicle independent of the at least two acquisition devices, wherein the analyzing step further includes analyzing the third item of information with regard to whether the triggering conditions are established independent of analyzing the first and second items of information, and wherein the irreversible retaining device is only triggered when results of the analyses of the first, second and third items of information indicate that the triggering conditions are established.

3. The method of claim 1, further comprising determining triggering parameters which are necessary for the triggering as a function of the first and second items of information.

4. The method of claim 1, wherein the at least two acquisition devices are of different types.

5. The method of claim 4, wherein each of the at least two acquisition devices is constructed as a member selected from the group consisting of a mono camera, a PMD sensor, a stereo camera and a radar sensor.

6. The method of claim 3, further comprising acquiring information relating to the object with a vehicle-to-vehicle-communication device, wherein the information is taken into account for analyzing whether the triggering conditions are established and/or for determining the triggering parameters.

7. A motor vehicle, comprising:
at least one irreversible retaining system which includes at least one retaining device and a control device for triggering the retaining device, said retaining device being triggerable before begin of an actual collision; and
at least two acquisition devices which operate independent of one another and continuously measure a vicinity of the motor vehicle, wherein one of the at least two acquisition devices is configured to acquire a first item of information relating to an object which is present in the vicinity of the motor vehicle, and another one of the at least two acquisition devices is configured to acquire a second item of information relating to the object independent of the one of the at least two acquisition devices, wherein the control device is configured to analyze the first and second items of information independent of one another with regard to whether triggering conditions for triggering the at least one retaining device are established and to trigger the at least one retaining device only when results of the analyses of the first and second items of information indicate that the triggering conditions are established.

8. The Motor vehicle of claim 7, further comprising a further acquisition device for acquiring a third item of information relating to the object, wherein the control device is configured to analyze the first, second and third items of information independent of one another with regard to whether the triggering conditions are established and to trigger the at least one irreversible retaining device only when results of the analyses of the first, second and items of information indicate that the triggering conditions are established.

9. The motor vehicle of claim 7, wherein the control device is configured for determining triggering parameters which are required for the triggering the at least one irreversible retaining device as a function of the first and second items of information.

10. The motor vehicle of claim 7, wherein the at least two acquisition devices are of different types.

11. The motor vehicle of claim 10, wherein each of the at least two acquisition devices is constructed as a member selected from the group consisting of a mono camera, a PMD sensor, a stereo camera and a radar sensor.

12. The motor vehicle of claim 9, further comprising a vehicle-to-vehicle-communication device for acquiring information relating to the object, wherein the control device is configured to analyze the information with regard to whether the triggering conditions are established and/or to determine the triggering parameters.
